(19) United States
(12) Patent Application Publication
(10) Pub. No.: US 2009/0118413 A1
(43) Pub. Date: May 7, 2009

(54) Composite materials for fuel containment

(76) Inventors: Christopher Brown, Merritt Island, FL (US); Marvin Peplow, Bartlett, IL (US)

Correspondence Address: CLIFFORD H. KRAFT, 320 ROBIN HILL DR., NAPERVILLE, IL, 60540, US

(21) Appl. No.: 12/288,720

(22) Filed: Oct. 22, 2008

Related U.S. Application Data
(60) Provisional application No. 61/000,311, filed on Oct. 25, 2007.
(60) Provisional application No. 61/004,354, filed on Nov. 27, 2007.

(51) Int. Cl. C08K 3/04

(52) U.S. Cl. 524/445; 524/599; 524/513; 524/586; 977/902

(57) ABSTRACT

An enhanced polymer for containing fuel such as in fuel tank construction that uses an one of several commercially available polymers or polymer blends and mixes or blends it with either carbon nano-tubes or carbon nano-fibers and/or with nano-sized smectite clay platelets. The polymer can be further hardened or stiffened by adding or blending or treating with a cross-linking agent. The polymers can be any suitable polymer; however, high density polyethylene, polybutylene terephtalate, polycarbonate or polybutylene terephtalate and polycarbonate blend are preferred. The carbon nano-fibers can have diameters from 50-70 nano-meters and have lengths up to several hundred microns. Generally carbon fibers are not used with polyethylene, only smectite clay. When blended and exfoliated appropriately, the resulting polymers, when molded into a part, exhibit a slower rate of burn when subject to flame tests and exhibit an increase in physical properties, including but not limited to barrier, chemical resistance (including hydrocarbons), stiffness and hardness.

This application claims priority to U.S. Provisional Patent applications Nos.: 61/000,311 filed Oct. 25, 2007 and 61/004,354 filed Nov. 27, 2007. Applications 61/000,311 and 61/004,354 are hereby incorporated by reference.

### BACKGROUND

1. Field of the Invention

The present invention relates to a blend of Polybutylene Terephtalate with nano-particles which has characteristics conducive to hydrocarbon containment and additional benefits of fire retardant and increased physical strength properties. In addition, it also relates to a blend of Polyethylene, also with nano-particles which has characteristics conducive to hydrocarbon containment and additional benefits of increased physical strength properties. The resulting polymers can be used with or without additional cross-linking.

2. Background of the Invention

Fuel tanks used for the portable transporting of fuel or permanently mounted fuel storage applications, most commonly associated with spark ignition engines, currently employ a range of molded polymers using different types of hydrocarbon barrier controls. Polymers used in fuel tanks can preferably be blow-molded and have certain required cold drop test properties and fire retardant properties.

One of these polymers is polyethylene, which can be classified into several different categories based mostly on its density and branching. A particular type of polyethylene found in this application is high density polyethylene. The mechanical properties of polyethylene depend significantly on variables such as the extent and type of branching, the crystal structure and the molecular weight. Another common is polymer for this application is polybutylene terephtalate or a blend of polybutylene terephthlate and polycarbonate.

It would be advantageous to have a blend of high density polyethylene or polybutylene terephtalate which has characteristics conducive to hydrocarbon containment and increased physical strength properties.

### SUMMARY OF THE INVENTION

The present invention relates to an enhanced polymer for containing fuel such as in fuel tank construction that uses an one of several commercially available polymers or polymer blends and mixes or blends it with either carbon nano-tubes or carbon nano-fibers and/or with nano-sized smectite clay platelets. The polymer can be further hardened or stiffened by adding or blending or treating with a cross-linking agent. The polymers can be any suitable polymer; however, high density polyethylene, polybutylene terephtalate, polycarbonate or polybutylene terephtalate and polycarbonate blend are preferred. The carbon nano-fibers can have diameters from 50-70 nano-meters and have lengths up to several hundred microns. Generally, carbon nano-fibers are not used with polyethylene, just smectite clay. When blended and exfoliated appropriately, the resulting polymers, when molded into a part, exhibit a slower rate of burn when subject to flame tests and exhibit an increase in physical properties, including but not limited to barrier, chemical resistance (including hydrocarbons), stiffness and hardness.

### DESCRIPTION OF THE INVENTION

In a first embodiment of the present invention, polybutylene terephtalate blend known in the art can be mixed (blended) and exfoliated with around 0.1 to 0.1-3% by weight or less of a carbon nano sized fiber with around 0.5% being preferred. A preferred nano-fiber is around 50-70 nano-meters in diameter and up to several hundred microns in length). While this is the preferred size of the nano-fiber, any diameter or length of nano-fiber is within the scope of the present invention.

The composite of the first embodiment of the invention can be additionally blended and exfoliated with around 5-6% by weight or less (from a fraction of a percent such as 0.1% up to around 5-6%) of a smectite clay platelet known in the art modified to exist in nano size. This additional blending forms a second embodiment of the present invention. Smectite clay platelets are known in the art and sold under such names as NANOMER (TM) by Nanocor Inc. and CLOISITE (TM) by Southern Clay Products Inc.

The polybutylene terephtalate blend of the first embodiment can also be blended and exfoliated with around 5-6% by weight or less of a smectite clay platelet modified to a nano size without any carbon fibers to form a third embodiment of the present invention.

A combined polybutylene terephtalate and polycarbonate blend known in the art can be blended and exfoliated with around 0.1-3% by weight with a preferred percentage of around 0.5% of a carbon nano sized fiber similar to that of the first embodiment to form a fourth embodiment of the present invention.

The composite of the fourth embodiment of the invention can be additionally blended and exfoliated with around 5-6% by weight or less of smectite clay platelets modified into a nano size to form a fifth embodiment of the present invention.

The polybutylene terephtalate and polycarbonate blend can be blended and exfoliated with around 5-6% by weight or less of smectite clay platelets modified to form a nano size without carbon fibers to form a sixth embodiment of the present invention.

When blended and exfoliated appropriately in these proportions the resulting polymers, when molded into a part, exhibit a slower rate of burn when subject to flame tests and exhibit an increase in physical properties, including but not limited to barrier, chemical resistance (including hydrocarbons), stiffness and hardness.

In a seventh embodiment of the present invention, commonly known and commercially available high density polyethylene can be blended and exfoliated with from a fraction of a percent (say around 0.1%) to around 5-6% by weight of nano-meter sized smectite clay platelets previously described. The preferred percentage is around 5% by weight. Generally, carbon nano-fibers are not used with polyethylene, just smectite clay.

The resulting clay enhanced polyethylene polymer may be used directly or further cross-linked by the use of cross-linking methods such as silane technology known in the art of polyethylene resins. Cross-linking the structure increases the original physical properties of the product such as hardness and stiffness. These cross-links exist as primary bonds which are chemically attached to the polyethylene chains. The cross-links further improve the long-term performance. Cross-linking can be accomplished by using vinylsilane also called vinyl silane or ethenyl silane, which is an organic derivative of silane. Vinylsilane is known in the art as a cross-linking product for polyethylene. An example of a commercially vinylsilane product is the PAXON 7000 (TM) series sold by Exxon Mobile Corp.

Prior to the adding of any cross linking products, the polyethylene should be blended and exfoliated with from a fraction of a percent to around 5-6% by weight of nano-meter sized smectite clay platelets as previously described.

When blended and exfoliated in these proportions, the resulting polymer, when molded into a part, exhibits a slower rate of hydrocarbon migration through the carrier matrix. The clay platelets deliver a torturous path for the hydrocarbon molecules to pass though subsequently resulting in a retarded rate of absorption, saturation and permeation and ultimately evaporation. The high density polyethylene also exhibits an increase in physical properties, including but not limited to other chemical resistance, stiffness and hardness.

Several descriptions have been given to aid in understanding the present invention. One skilled in the art will realize that numerous changes and variations are possible without departing from the spirit of the invention. Each of these changes and variations is within the scope of the present invention.

We claim:

1. An enhanced blended polymer material for fuel containment comprising a polymer chosen from the group consisting of polybutylene terephtalate, polycarbonate and polybutylene/polycarbonate blend blended with around 0.1% to around 3% by weight of carbon nano-fiber.

2. The enhanced blended polymer material of claim 1 blended with around 0.5% by weight of carbon nano-fiber.

3. The enhanced blended polymer material of claim 1 further comprising the material of claim 1 blended from around 0.1% to around 6% by weight of nano-sized smectite clay platelets.

4. The enhanced blended polymer material of claim 2 blended with around 5% by weight of nano-sized smectite clay platelets.

5. The enhanced blended polymer material of claim 1 further comprising adding a sufficient amount of a cross-linking agent to cause cross-linking of the polymer.

6. The enhanced blended polymer material of claim 2 further comprising adding a sufficient amount of a cross-linking agent to cause cross-linking of the polymer.

7. An enhanced blended polymer material for fuel containment comprising a polymer chosen from the group consisting of high density polyethylene, polybutylene terephtalate, polycarbonate and polybutylene/polycarbonate blend blended with around 0.1% to around 6% by weight of nano-sized smectite clay platelets.

8. The enhanced blended polymer material of claim 7 further comprising adding a sufficient amount of a cross-linking agent to cause cross-linking of the polymer.

9. A method for producing an enhanced blended polymer material comprising:
choosing a first component as a polymer from the group consisting of high density polyethylene, polybutylene terephtalate, polycarbonate and polybutylene and terephtalate/polycarbonate blend;
blending in around 0.1 to 6% by weight of nano-sized smectite clay platelets.

10. The method of claim 9 further comprising blending in around 0.1 to 0.6% by weight of carbon nano-fibers when said chosen polymer is polybutylene terephthlate, polycarbonate or polybutylene terephthalate/polycarbonate.

11. The method of claim 9 further comprising blending in a sufficient amount of cross-linking agent to cause cross linking of said polymer.

12. The method of claim 10 further comprising blending in a sufficient amount of cross-linking agent to cause cross linking of said polymer.

13. The method of claim 9 blended with around 5% by weight of nano-sized smectite clay platelets.

14. The method of claim 10 blended with around 0.5% of carbon nano-fibers.
